(19) United States
(12) Patent Application Publication
(10) Pub. No.: US 2015/0355105 A1
(43) Pub. Date: Dec. 10, 2015

(54) Inspection Apparatus

(71) Applicant: HITACHI HIGH-TECHNOLOGIES CORPORATION, Minato-ku, Tokyo (JP)

(72) Inventor: Hiroyuki YAMASHITA, Tokyo (JP)

(73) Assignee: Hitachi High-Technologies Coporation, Minato-ku, Tokyo (JP)

(21) Appl. No.: 14/655,493

(22) PCT Filed: Dec. 19, 2013
(86) PCT No.: PCT/JP2013/084131

§ 371 Date: Jun. 25, 2015

(30) Foreign Application Priority Data
Jan. 17, 2013 (JP) 2013-006500

(51) Int. Cl. G01N 21/95; G01N 21/956

(52) U.S. Cl. CPC G01N 21/9501; G01N 21/95607

(57) ABSTRACT

An inspection apparatus capable of accurately detecting a defect regardless of the difference between peripheral parts formed around cell parts is realized. Dies 201 to 2N1 arrayed on a wafer are produced with identical specifications to each other, and a plurality of cell parts 202 to 20n produced by repetition of identical patterns is formed. A peripheral part is formed between a cell part and another cell part. Since the peripheral part is provided in a plurality of types such as patterns A, B, C, even cell parts having the same shape as each other may have different cross-sectional images due to the influence of the difference between the surrounding peripheral parts. Thus, in order to prevent occurrence of false information in a cell part area near the peripheral part, cell parts having the same surrounding peripheral parts are aligned with each other, then the difference is detected, and whether there is a defect or not is determined. Thus, occurrence of false information is prevented.

### TECHNICAL FIELD

The present invention relates to an inspection apparatus which detects defects such as scratches and foreign matters on a sample.

### BACKGROUND ART

A semiconductor element is produced by performing various kinds of processing on a silicon wafer. If a silicon wafer is scratched or a foreign matter is attached to the silicon wafer in the course of the semiconductor manufacturing process, malfunction of the semiconductor element will occur.

Therefore, in order to improve yield, it is important detect a defect such as a scratch or foreign matter on the wafer and feed the result thereof back to the semiconductor manufacturing process. What is used for detection of a defect on the semiconductor wafer is a so-called inspection apparatus, and an apparatus which detects a defect using light may be called an optical inspection apparatus.

An optical inspection apparatus is roughly classified as a surface inspection apparatus which inspects a so-called bare wafer where no pattern is formed, or as a patterned wafer inspection apparatus which inspects a wafer where a pattern is formed.

With respect to patterned wafer inspection apparatus, a technique of detecting a defect by comparing dies or comparing cell parts, calculating a differential image and determination with a threshold, is known, as disclosed in PTL 1.

Here, a die is a silicon wafer chip on which an integrated circuit is printed, and a cell part is an area formed within the die where a minimum repetition pattern is formed.

### CITATION LIST

### Patent Literature

PTL 1: JP-A-2007-33073

### SUMMARY OF INVENTION

### Technical Problem

In the technique described in the above PTL 1, alignment processing of dies or cell parts with each other needs to be carried out. A circuit pattern called a peripheral part is formed around the cell parts. This peripheral part does not have the same pattern with respect to each cell part of a plurality of cell parts. For example, an A-pattern may be formed in the left area of a cell part and a B-pattern may be formed in the right area, whereas a B-pattern is formed in the left area of another cell part and a C-pattern is formed in the right area.

Therefore, when cells next to each other within the same die are aligned with each other and a difference is detected, if the peripheral parts in the left areas around the respective cells or the peripheral parts in the right areas are different from each other, it is detected as a difference and therefore it may not be possible to carry out accurate defect detection.

Meanwhile, in order to compare dies, alignment of the dies with each other needs to be carried out. However, if the dies have a large size, misalignment tends to occur and it may not be possible to carry out alignment processing correctly.

Thus, with the related-art technique, it is difficult to improve the defect detection accuracy.

It is an object of the invention to realize an inspection apparatus capable of accurately detecting a defect regardless of the difference between peripheral parts formed around cell parts.

### Solution to Problem

To achieve the above object, the invention is configured as follows.

In an inspection apparatus, an inspection target has a plurality of dies formed thereon, each of the dies having an integrated circuit including a plurality of cell parts formed to have an identical circuit pattern with each other and a plurality of peripheral parts formed on two sides of each cell part of the plurality of cell parts and having a circuit pattern formed therein. The plurality of peripheral parts has a plurality of types of circuit patterns. An arithmetic processing unit extracts cell parts having the same arrangement order of the circuit pattern in the peripheral part formed on one of the two sides and the circuit pattern in the peripheral part formed on the other of the two sides, from among the plurality of cell parts formed in one die, carries out alignment so that the cell parts having the same arrangement order of the circuit patterns in the peripheral parts overlap with each other, calculates a differential image, determines whether the calculated difference is equal to or below a threshold, or not, and thereby detects a defect.

### Advantageous Effect of Invention

An inspection apparatus capable of accurately detecting a defect regardless of the difference between peripheral parts formed around cell parts can be realized.

### BRIEF DESCRIPTION OF DRAWINGS

FIG. 1 is an overall schematic configuration view of a defect inspection apparatus to which Example 1 of the invention is applied.

FIG. 2 is an explanatory view of dies 201 to 2N1 arrayed on a patterned wafer 200.

FIG. 3 is a view showing a cross-sectional image of a cell part and peripheral parts on two sides thereof.

FIG. 4 is an explanatory view about alignment of cell parts with each other in a die.

FIG. 5 is an explanatory view about alignment of cell parts with each other in a die.

FIG. 6 is an internal functional block diagram relating to defect determination processing by an arithmetic processing unit.

FIG. 7 is an operation flowchart of defect inspection based on a second method.

FIG. 8 is an operation flowchart of detect inspection based on a first method.

FIG. 9 is an explanatory view of Example 2 of the invention.

FIG. 10 is an explanatory view of Example 2 of the invention.

FIG. 11 is an explanatory view of a method for obtaining a statistical threshold in Example 3 of the invention.

### DESCRIPTION OF EMBODIMENTS

Hereinafter, embodiments of the invention will be described in detail on the basis of the drawings.

It should be noted that parts having the same function are basically denoted by the same reference number throughout the drawings for explaining the embodiments of the invention and that repeated explanation thereof is omitted as much as possible.

### Examples

### Example 1

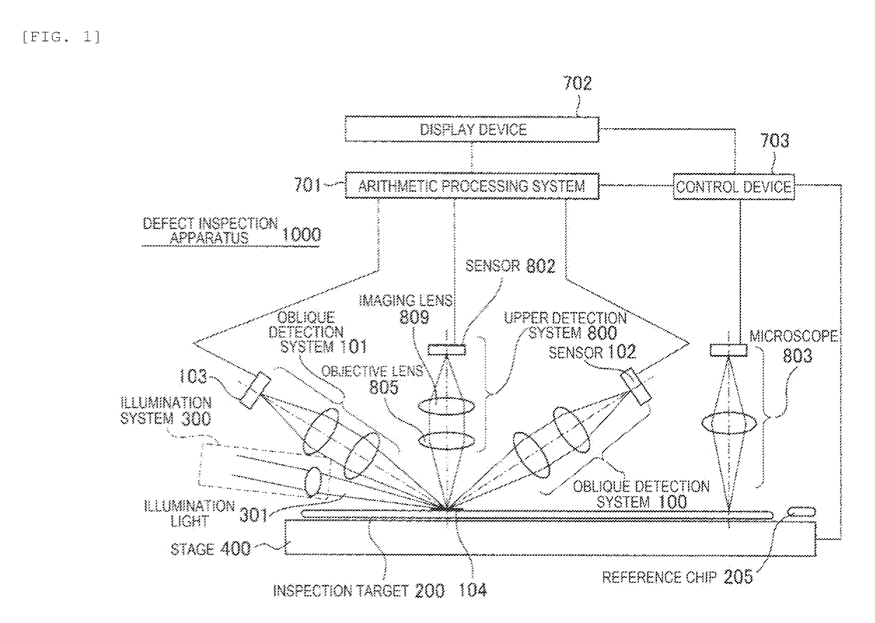

FIG. 1 is an overall schematic configuration view of a defect inspection apparatus 1000 to which Example 1 of the invention is applied. Referring to FIG. 1, in the inspection apparatus, an inspection target 200 which is a patterned wafer is loaded on a stage (support stage) 400 as a conveyor system (conveyor unit). An illumination system (illumination unit) 300 illuminates the inspection target 200 with illumination light 301 and forms a linear illumination area 104.

The light from the illumination area 104 is detected by oblique detection systems (oblique detection units) 100, 101 and an upper detection system (upper detection unit) 800. The upper detection system 800 has an objective lens 805 and an imaging lens 809. The oblique detection systems (oblique detection units) 100, 101 similarly have an objective lens and an imaging lens.

Also, the oblique detection systems 100, 101 and the upper detection system 800 include a spatial filter and a zoom lens arranged on the Fourier plane. Moreover, the oblique detection systems 100, 101 and the upper detection system 800 have sensors 102, 103, 802 such as a one-dimensional CCD line sensor or two-dimensional TDI sensor, and a dark-field image that is formed is detected by these. The dark-field image detected by the sensors 102, 103, 802 is transmitted to an arithmetic processing system (arithmetic processing unit) 701 as a detection signal, and a defect is detected from the resulting dark-field image.

The image obtained by the arithmetic processing system 702 is displayed by a display device 702. 205 is a reference chip and 803 is a microscope. A control device 703 controls the operations of the microscope 803, the stage 400, the display device 702 and the arithmetic processing system 701.

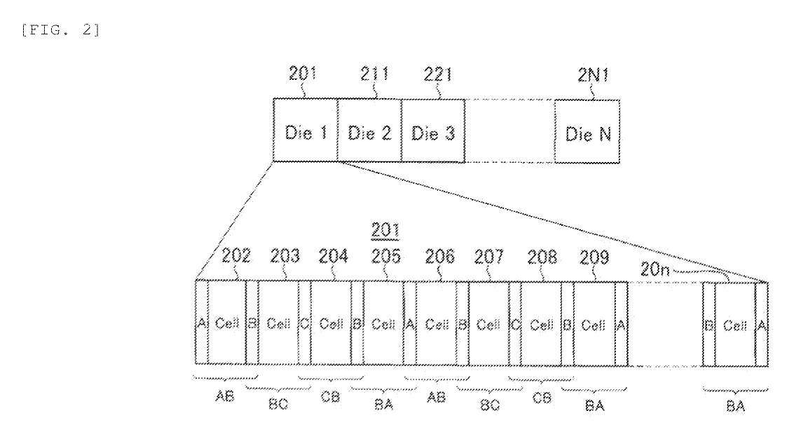

FIG. 2 is an explanatory view of dies 201 to 2N1 arrayed on the patterned wafer 200 (N being a natural number). In FIG. 2, since the dies 201 to 2N1 are produced on the basis of the identical specifications with each other, the pattern array in a die will be explained using the die 201 as an example.

In the die 201, a plurality of cell parts 202 to 20n produced with repetition of an identical pattern to each other is formed. Also, a peripheral part is formed on two sides of the cell parts. These structures can be expressed as a cyclical structure (repetitive structure) formed in the die.

In the peripheral parts, a peripheral circuit pattern of the cell parts is formed, as described above. However, not all the peripheral parts have the same circuit pattern formed therein and there is a plurality of types such as patterns A, B and C, as shown in FIG. 2.

Therefore, for example, peripheral parts A and B are formed on the two sides of the cell part 202 and peripheral parts B and C are formed on the two sides of the cell part 203.

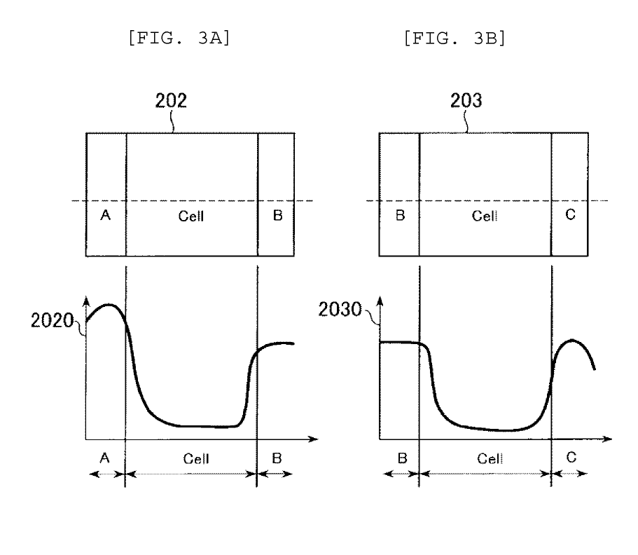

FIG. 3 is a view showing a cross-sectional image of the cell part 202 and the peripheral parts on the two sides thereof (FIG. 3(a)) and a cross-sectional image of the cell part 203 and the peripheral parts on the two sides thereof (FIG. 3(b)). Although the cell parts 202 and 203 are in the same shape, the cell parts 202 and 203 have different cross-sectional images due to the influence of the difference between the peripheral parts on the two sides.

In the case where the cell part 202 and the cell part 203 are compared and inspected and the difference is calculated to determine whether there is a defect or not, since false information is generated in the cell part areas near the peripheral parts, a large difference is generated despite the cell parts 202 and 203 being identical. Therefore, there are cases where accurate defect detection cannot be carried out.

In Example 1 of the invention, in order to prevent the generation of false information in the cell part areas near the peripheral parts, cell parts having the same the peripheral parts on the two sides are aligned with each other, then the difference is detected, and whether there is a defect or not is determined. Thus, the generation of false information is prevented.

For example, the cell parts 202 and 206 both have the surrounding peripheral parts A and B. Therefore, the cell parts 202 and 206 are aligned with each other, then the difference is detected, and whether there is a defect or not is determined. Also, the cell parts 203 and 207 both have the peripheral parts B and C on the two sides (surroundings). Therefore, the cell parts 203 and 207 are aligned with each other so as to overlap with each other, then the difference is detected, and whether there is a defect or not is determined. The same applies to the cell parts 204 and 208 and the cell parts 205 and 209.

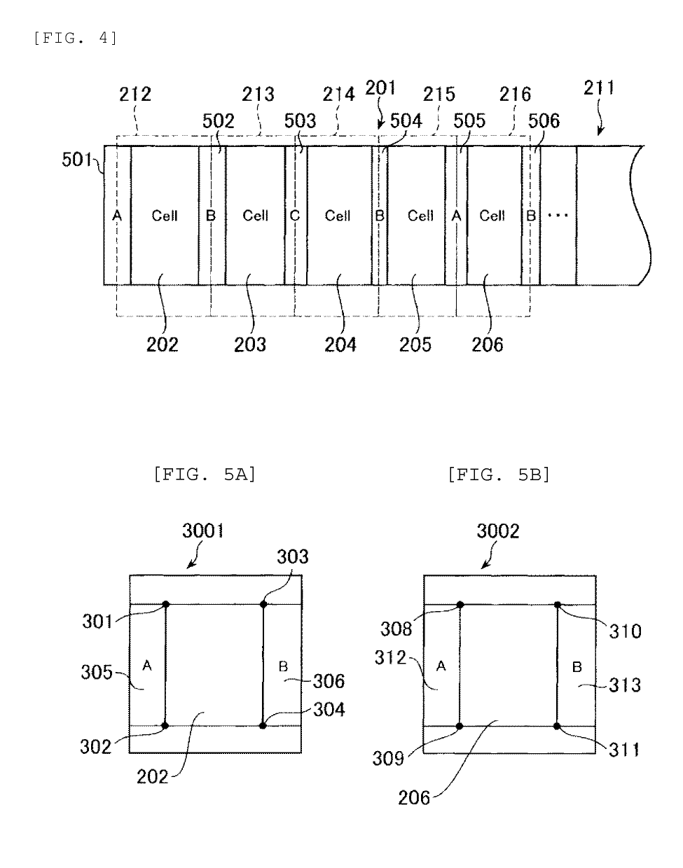

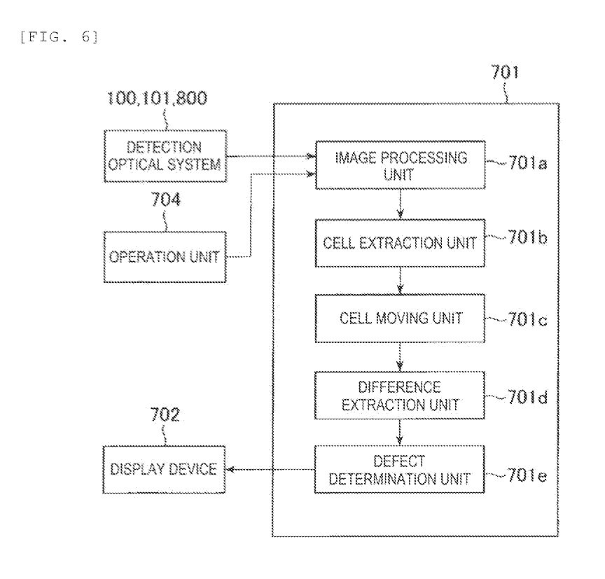

Next, the alignment of cell parts with each other will be described. FIG. 4 and FIG. 5 are explanatory views about the alignment of the cell parts with each other in the die 201. The example shown in FIG. 4 and FIG. 5 is an example in which the coordinates of the boundary between a dark part and a bright part in a dark-field image.

In FIG. 4, with respect to the cell part 202, a dark-field image of an area including a part of peripheral parts 501, 502 is acquired, as indicated by a dashed line 212. Also, with respect to the cell part 203, a dark-field image of an area including a part of peripheral parts 502, 503 is acquired, as indicated by a dashed line 213. Also, with respect to the cell part 204, a dark-field image of an area including a part of peripheral parts 503, 504 is acquired, as indicated by a dashed line 214. With respect to the cell part 205, a dark-field image of an area including apart of peripheral parts 504, 505 is acquired, as indicated by a dashed line 215. Also, with respect to the cell part 206, a dark-field image of an area including a part of peripheral parts 505, 506 is acquired, as indicated by a dashed line 216. Subsequently, a dark-field image is similarly acquired with respect to each cell part.

FIG. 5 is a view for explaining the alignment of cell parts, using the alignment of the cell parts 202 and 206 as an example.

FIG. 5(a) shows a dark-field image 3001 in the area of the part indicated by the dashed line 212 in FIG. 4. FIG. 5(b) shows a dark-field image 3002 in the area of the part indicated by the dashed line 216 in FIG. 4.

The arithmetic processing unit 701 calculates, with respect to the dark-field image 3001, the coordinates of boundary points 301, 302, 303, 304 between the dark-field image in the cell part 202, and a dark-field image 305 in the peripheral part 501 and a dark-field image 306 in the peripheral part 502. Similarly, the arithmetic processing unit 701 calculates, with respect to the dark-field image 3002, the coordinates of boundary points 308, 309, 310, 311 between the dark-field image in the cell part 206, and a dark-field image 312 in the peripheral part 505 and a dark-field image 313 in the peripheral part 506.

Then, the arithmetic processing unit 701 moves at least one of the dark-field images 3001 and 3002 in such a way that the distance between the coordinates, of at least one set (preferably all) of the coordinates of the boundary point 301 and the coordinates of the boundary point 308, the coordinates of the boundary point 302 and the coordinates of the boundary point 309, the coordinates of the boundary point 303 and the coordinates of the boundary point 310, and the coordinates of the boundary point 304 and the coordinates of the boundary point 311, falls within an allowable range (preferable coincides).

Since the moving distance for alignment of the dark-field images 3001 and 3002 is shorter than the moving distance in the case of aligning the dies 201 and 211, there is less influence of misalignment and more accurate alignment is possible.

The alignment of the other cell parts is executed similarly.

It should be noted that, though the above example is an example where the coordinates of the boundary between the dark part and the bright part in the dark-field image is used for alignment of cell parts with each other, cell parts can be aligned with each other using other methods. For example, alignment can be carried out using the behavior of a characteristic signal that appears in common to different dark-field images.

After the alignment of the above cell parts is carried out, processing to calculate the difference between the images is carried out. There are two types of methods for calculating the difference between the images.

The first method is a method in which the difference is calculated on a die basis after the above cell parts are aligned with each other.

The second method is a method in which the difference between the dark-field images is calculated after the cell parts in the die are aligned with each other.

As for which method to select, a select button can be displayed on the display device 702 so that the operator or the like can arbitrarily select a method.

Then, with respect to the differential image calculated by the first method or the second method, whether there is a defect or not is determined using a threshold.

FIG. 6 is an internal functional block diagram relating to the defect determination processing by the arithmetic processing unit 701. In FIG. 6, the arithmetic processing unit 701 has an image processing unit 701a which forms an image of an inspection target, a cell extraction unit 701b, a cell moving unit 701c, a difference calculation unit 701d, and a defect determination unit 701e. Also, an operation unit 704 such as a keyboard and mouse is provided on the inspection apparatus according to Example 1 of the invention, though not illustrated in FIG. 1. With a command from this operation unit 704, a method for image processing or the like is designated to the image processing unit 701a.

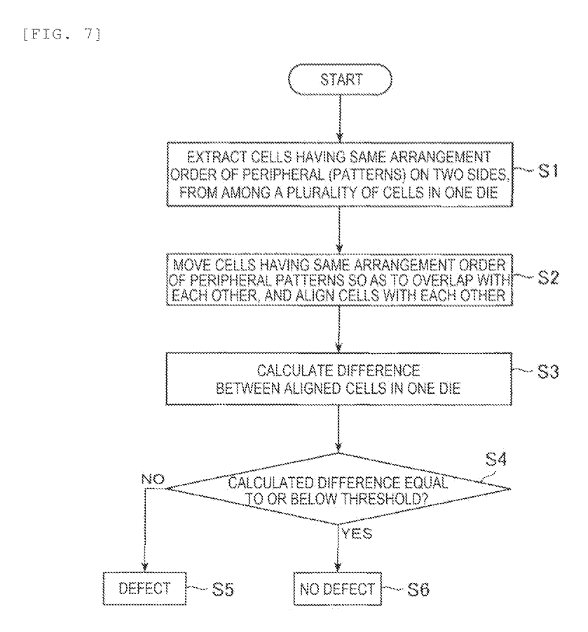

FIG. 7 is an operation flowchart of defect inspection based on the above second method. In Step S1 in FIG. 7, with respect to the image processed by the image processing unit 701a on the basis of the signals from the detection optical systems 100, 101, 800, the cell extraction unit 701b extracts cells having the same arrangement order of the patterns in the peripheral parts on the two sides, from among the plurality of cell parts formed in one die (for example, the cell parts 202 and 206, and the cell parts 203 and 207 shown in FIG. 2).

Next, in Step S2, the cell moving unit 701c moves the cell parts in such a way that the cell parts having the same arrangement order of the patterns in the peripheral parts overlap with each other, and then carries out alignment.

Subsequently, in Step S3, the difference calculation unit 701d calculates the difference between the cell parts aligned with each other in the one die. Then, in Step S4, the defect determination 701e determines whether the calculated difference is equal to or below a threshold, or not. If the difference is above the threshold, the defect determination unit 701e determines that there is a defect (Step S5). If the difference is equal to or below the threshold, the defect determination unit 701e determines that there is no defect (Step S6).

The result of the determination on whether there is a defect or not is transmitted from the defect determination unit 701e to the display device 702 and displayed on the display device 702.

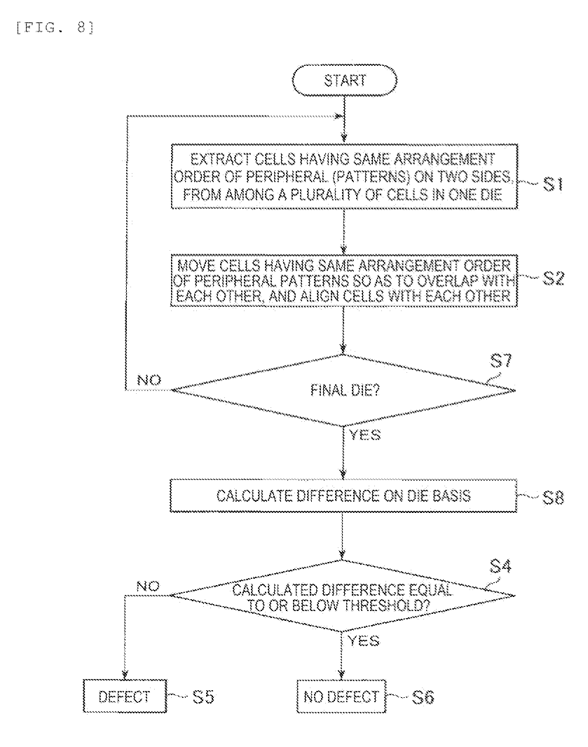

FIG. 8 is an operation flowchart of detect inspection based on the above first method.

In FIG. 8, Steps S1, S2 are similar to the flowchart shown in FIG. 7. Then, in Step S7, the cell moving unit 701c determines whether the alignment of cell parts is carried out in the final die of the dies to be inspected, or not. If it is not the final die, the processing returns to Step S1 to carry out alignment of cell parts in the next die.

If it is determined in Step S7 that the alignment of cell parts is carried out in the final die, the processing goes to Step S8 and the difference calculation unit 701d carries out alignment so that the dies overlap with each other, and then calculates the difference on a die basis. After that, processing similar to Steps S4 to S5 shown in FIG. 7 is carried out.

As described above, according to Example 1 of the invention, since the alignment of cell parts having the same arrangement order of the peripheral parts on the two sides is carried out in the same die and the difference is calculated to determine whether there is a defect or not, an inspection apparatus capable of accurately detecting a defect, regardless of the difference between the peripheral parts formed on the two sides of the cell parts, can be realized.

Also, according to Example 1 of the invention, whether there is a defect or not can be determined by aligning cell parts having the same arrangement order of the surrounding peripheral parts and extracting the difference between a plurality of dies. Also in the case, an inspection apparatus capable of accurately detecting a defect, regardless of the difference between the peripheral parts formed on the two sides of the cell parts, can be realized.

### Example 2

Next, Example 2 of the invention will be described.

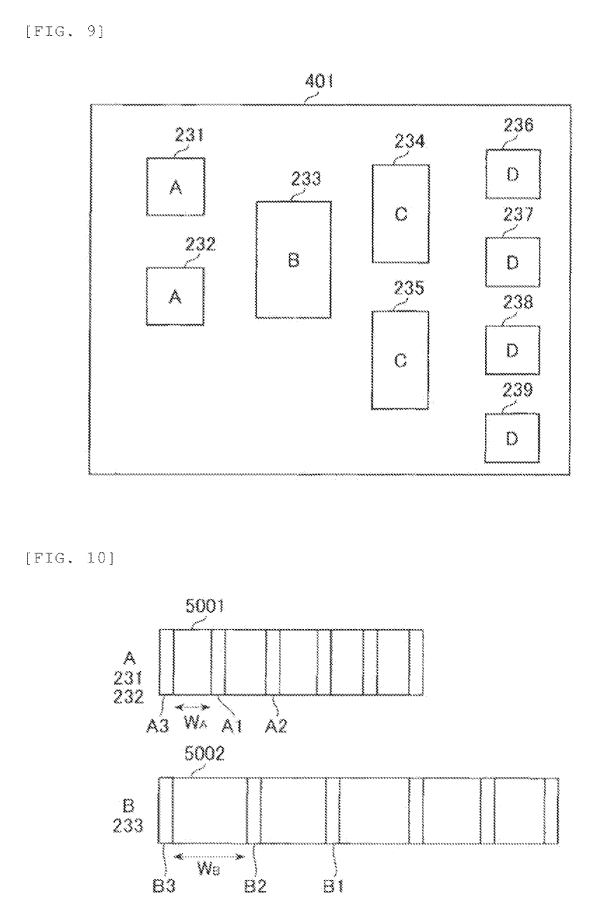

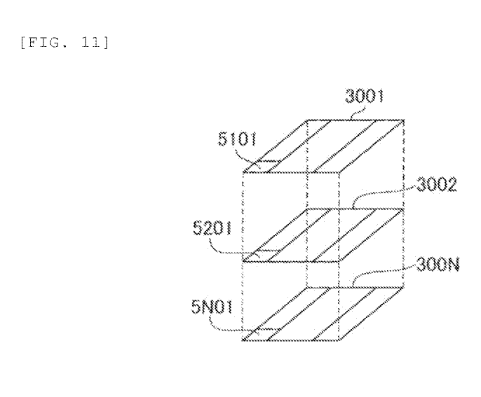

FIG. 9 and FIG. 10 are explanatory views of Example 2 of the invention. In Example 1, the plurality of dies formed on the patterned wafer is dies of one type produced with the identical specifications to each other. However, there are cases where the plurality of dies formed on the patterned wafer is not limited to one type and where a plurality of types of dies is formed.

For example, as shown in FIG. 9, there is a case where mutually different types of dies A (231, 232), B (233), C (234, 235), and D (236 to 239) are distributed in part 401 of a patterned wafer.

FIG. 10 is a detailed explanatory view of the dies A, B. The width WA of a cell part 5001 in the die A and the width WB of a cell part 5002 in the die B are different from each other. Moreover, the types (A3, A1) of the left and right peripheral parts of the cell part 5001 and the types (B3, B2) of the left and right peripheral parts of the cell part 5002 are different from each other.

Therefore, in Example 2 of the invention, the range (size) of the area where a dark-field image is obtained, the position of the boundary point used for alignment, and the misalignment that is allowable in alignment are changed according to the type of the die, then alignment is carried out, and the difference is calculated. The alignment method and the calculation of the difference in this die are executed similarly to Example 1.

The change in the range of the area where a dark-field image is obtained, the position of the boundary point used for alignment, and the misalignment that is allowable in alignment, is carried out according to a command from the operation unit 701a shown in FIG. 6. The command from the operation unit 701a can be set by the operator, for each type of die.

The overall configuration of the inspection apparatus and the internal functional configuration of the arithmetic processing unit 701 are similar to Example 1 and therefore illustration and description thereof are omitted.

According to Example 2 of the invention, an inspection apparatus capable of accurately detecting a defect regardless of the difference between the peripheral parts formed around the cell parts even if mutually different types of dies are distributed in a part of the patterned wafer, can be realized.

### Example 3

Next, Example 3 of the invention will be described.

In the inspection apparatus, a threshold (statistical threshold) utilizing a standard deviation of pixels in a dark-field image may be used at the time of threshold processing in the defect presence/absence determination on a wafer. When a statistical threshold is used, it is better as the number of pixels used becomes larger. Example 3 of the invention is configured to determine whether there is a defect or not, using a statistical threshold, in Examples 1 or 2.

FIG. 11 is an explanatory view of a method for obtaining a statistical threshold in Example 3 of the invention. In Example 3 of the invention, dark-field images 3001, 3002, . . . 300N corresponding to a repetition structure in the above die 201 are used.

In FIG. 11, a standard deviation is calculated using the values of pixels with corresponding coordinates in difference dark-field images. That is, a standard deviation is calculated using the values of pixels 5101, 5201, . . . 5N01 with the coordinates thereof corresponding to each other. For the other pixels, a standard deviation is calculated similarly. This processing is executed by the image processing unit 701a in the arithmetic processing unit 701.

Then, the image processing unit 701a stores the standard deviation of each of the pixels with the corresponding coordinates, and at the time of defect detection, the defect determination unit 701e uses the standard deviation stored in the image processing unit 701a as a threshold.

Thus, the number of samples at the time of obtaining a statistical threshold can be increased and therefore a more accurate statistical threshold can be obtained.

The overall configuration of the inspection apparatus and the internal functional configuration of the arithmetic processing unit 701 are similar to Example 1 and therefore illustration and description thereof are omitted.

According to Example 3 of the invention, again, an inspection apparatus capable of accurately detecting a defect regardless of the difference between the peripheral parts formed around the cell parts even if mutually different types of dies are distributed in a part of the patterned wafer, can be realized.

It should be noted that the invention is not limited to the above examples and that various modifications can be made within the scope of the invention. For example, the detection optical system may be provided in a plural number or may be single. In the case of a plurality of detection optical systems, the range where a dark-field image is obtained, a configuration to change the boundary point used for alignment, and the misalignment that is allowable in alignment, for each detection optical system, can be provided.

Moreover, while the above examples are of an inspection apparatus using a dark-field image, the invention can also be applied to an inspection apparatus using a bright-field image.

### REFERENCE SIGNS LIST

100, 101 . . . oblique detection system, 102, 103, 802 . . . sensor, 104 . . . illumination area, 200 . . . inspection target, 300 . . . illumination system, 400 . . . stage, 701 . . . arithmetic processing system, 701a . . . image processing unit, 701b . . . cell extraction unit, 701c . . . cell moving unit, 701d . . . difference calculation unit, 701e . . . defect determination unit, 702 . . . display device, 703 . . . control device, 704 . . . operation unit, 1000 . . . defect inspection apparatus

1. An inspection apparatus comprising:
an illumination unit which illuminates an inspection target with light;
a detection optical unit which detects light from the inspection target; and
an arithmetic processing unit which detects a defect in the inspection target on the basis of a detection signal from the detection optical unit;
wherein the inspection target has a plurality of dies formed thereon, each of the dies having an integrated circuit including a plurality of cell parts formed to have an identical circuit pattern with each other and a plurality of peripheral parts formed on two sides of each cell part of the plurality of cell parts and having a circuit pattern formed therein, and the plurality of peripheral parts has a plurality of types of circuit patterns, and
the arithmetic processing unit extracts cell parts having a same arrangement order of the circuit pattern in the peripheral part formed on one of the two sides and the circuit pattern in the peripheral part formed on the other of the two sides, from among the plurality of cell parts formed in one die, carries out alignment so that the cell parts having the same arrangement order of the circuit patterns in the peripheral parts overlap with each other, calculates a differential image, determines whether the calculated difference is equal to or below a threshold, or not, and thereby detects a defect.

2. The inspection apparatus according to claim 1, wherein
the cell parts in the plurality of dies are formed to have a same circuit pattern, and the arithmetic processing unit extracts an area with a predetermined size including the peripheral parts on the two sides of the cell part and the cell part and carries out alignment so that the cell parts overlap with each other.

3. The inspection apparatus according to claim 1, wherein
the inspection target has a plurality of types of dies formed thereon, the dies having different types of circuit patterns in cell parts, and the arithmetic processing unit carries out extraction of the cells by extracting an area including peripheral parts on two sides of the cell part and the cell part, and changes a size of the area to be extracted, according to the type of the circuit pattern in the cell part.

4. The inspection apparatus according to claim 1, wherein
the arithmetic processing unit includes:
an image processing unit which forms an image of the inspection target;
a cell extraction unit which extracts cell parts having a same arrangement order of the circuit pattern in the peripheral part formed on one of the two sides of the cell part and the circuit part in the peripheral part formed on the other of the two sides;
a cell moving unit which carries out alignment so that the extracted cell parts having the same arrangement order of the circuit patterns in the peripheral parts on the two sides of the cell parts overlap with each other;
a difference calculation unit which calculates a differential image between the cell parts on which the alignment is carried out; and
a defect determination unit which determines whether the calculated difference is equal to or below a threshold, or not, and thus detects a defect.

5. The inspection apparatus according to claim 4, further comprising
a display device which displays a result of defect presence/absence determination by the defect determination unit.

6. The inspection apparatus according to claim 1, wherein
the arithmetic processing unit calculates a standard deviation of pixel value with respect to pixels at positions corresponding to each other in images of a plurality of cell parts in one die, and uses the calculated standard deviation as the threshold.

7. An inspection apparatus comprising:
a support stage which supports an inspection target;
an illumination unit which illuminates the inspection target with light;
a detection optical unit which detects reflected light from the inspection target; and
an arithmetic processing unit which detects a defect in the inspection target on the basis of a detection signal from the detection optical unit;
wherein the inspection target has a plurality of dies formed thereon, each of the dies having an integrated circuit including a plurality of cell parts formed to have an identical circuit pattern with each other and a plurality of peripheral parts formed on two sides of each cell part of the plurality of cell parts and having a circuit pattern formed therein, and the plurality of peripheral parts has a plurality of types of circuit patterns, and
the arithmetic processing unit extracts cell parts having a same arrangement order of the circuit pattern in the peripheral part formed on one of the two sides and the circuit pattern in the peripheral part formed on the other of the two sides, from among the plurality of cell parts formed in one die, with respect to each die of the plurality of dies, carries out alignment so that the cell parts having the same arrangement order of the circuit patterns in the peripheral parts overlap with each other, carries out alignment so that the dies on which the alignment is carried out overlap with each other, calculates a differential image, determines whether the calculated difference is equal to or below a threshold, or not, and thereby detects a defect.

8. The inspection apparatus according to claim 7, wherein
the cell parts in the plurality of dies are formed to have a same circuit pattern, and the arithmetic processing unit extracts an area with a predetermined size including the peripheral parts on the two sides of the cell part and the cell part and carries out alignment so that the cell parts overlap with each other.

9. The inspection apparatus according to claim 7, wherein
the inspection target has a plurality of types of dies formed thereon, the dies having different types of circuit patterns in cell parts, and the arithmetic processing unit carries out extraction of the cells by extracting an area including peripheral parts on two sides of the cell part and the cell part, and changes a size of the area to be extracted, according to the type of the circuit pattern in the cell part.

10. The inspection apparatus according to claim 7, wherein
the arithmetic processing unit includes:
an image processing unit which forms an image of the inspection target;
a cell extraction unit which extracts cell parts having a same arrangement order of the circuit pattern in the peripheral part formed on one of the two sides of the cell part and the circuit part in the peripheral part formed on the other of the two sides;
a cell moving unit which carries out alignment so that the extracted cell parts having the same arrangement order of the circuit patterns in the peripheral parts on the two sides of the cell parts overlap with each other;
a difference calculation unit which calculates a differential image between the cell parts on which the alignment is carried out; and
a defect determination unit which determines whether the calculated difference is equal to or below a threshold, or not, and thus detects a defect.

11. The inspection apparatus according to claim 10, further comprising
a display device which displays a result of defect presence/absence determination by the defect determination unit.

12. The inspection apparatus according to claim 7, wherein
the arithmetic processing unit calculates a standard deviation of pixel value with respect to pixels at positions corresponding to each other in images of a plurality of cell parts in one die, and uses the calculated standard deviation as the threshold.
